(19) United States
(12) Patent Application Publication
(10) Pub. No.: US 2014/0011268 A1
(43) Pub. Date: Jan. 9, 2014

(54) MICROCHIP FOR CHEMICAL REACTION AND METHOD FOR FABRICATING SAME

(71) Applicant: Sony Corporation, Tokyo (JP)

(72) Inventors: Masahiro Matsumoto, Kanagawa (JP); Tomohiko Nakamura, Tokyo (JP)

(21) Appl. No.: 13/927,434

(22) Filed: Jun. 26, 2013

(30) Foreign Application Priority Data
Jul. 4, 2012 (JP) 2012-150711

(51) Int. Cl. B01L 3/00

(52) U.S. Cl. CPC B01L 3/5027
USPC 435/289.1; 422/502; 29/829

(57) ABSTRACT

There is provided a microchip for chemical reaction in which a solid-phase reagent whose reagent composition can be identified based on appearance is contained.

### BACKGROUND

The present disclosure relates to a method for fabricating a microchip for chemical reaction. More specifically, the present disclosure relates to a microchip for chemical reaction in which a solidified reagent that includes at least one or more kinds of the substances required for a reaction is contained in a well that serves as a reaction site for a chemical reaction, such as a nucleic acid amplification reaction.

In recent years, microchips have been developed in which wells and channels for performing chemical and biological analyses are provided on a silicon substrate or a glass substrate by applying micro-machining techniques used in the semiconductor industry. These microchips have begun to be utilized for electrochemical detectors in, for example, liquid chromatography, compact electrochemical sensors in medical service locations and the like.

Analytical systems using such microchips are called μ-TAS (micro-Total-Analysis System), lab-on-a-chip, bio chip or the like. Attention is being paid to such microchips as a technology that enables chemical and biological analyses to be performed faster, with greater efficiency, and a higher level of integration, or that enables the analyzing apparatuses to be reduced in size. μ-TAS, which enables analysis with a small amount of sample and enables the disposable use of microchips, is expected to be applied particularly in biological analyses where precious trace amounts of samples or many specimens are handled.

An applied example of μ-TAS is an optical detection apparatus in which a substance is introduced into a plurality of areas arranged on the microchip, and the substance is optically detected. Such an optical detection apparatus may include a reaction apparatus (for example, a real-time PCR apparatus) that causes a reaction, such as a nucleic acid amplification reaction, between a plurality of substances to proceed in a well on the microchip, and optically detects the produced substances.

Microchip-type nucleic acid amplification apparatuses have conventionally employed a method in which the reaction is performed by mixing in advance all of the reagents and template DNA required for the nucleic acid amplification reaction, and introducing the mixed solution into a plurality of wells arranged on the microchip. However, with this method, since it takes a certain amount of time until the mixed solution is introduced into the wells, there is the problem that during that period the reaction proceeds in the mixed liquid, so that non-specific nucleic acid amplification tends to occur, thereby reducing quantitative performance.

In response to this problem, for example, JP-A-2011-160728 proposes a microchip in which a plurality of reagents required for a nucleic acid amplification reaction are laminated and fixed in order in the wells. As an example, the fabrication of a microchip is disclosed in which solid-phase reagents have been contained in each well by forming a substrate layer a1, fixing an enzyme in the wells, fixing a primer in the wells, activating the surface of substrate layers a1 and a2, and then bonding these substrate layers together.

### SUMMARY

However, the identification of the reagent composition of each reagent contained in the wells becomes more difficult. Thus, according to an embodiment of the present disclosure, there is provided a microchip, and a method for fabricating such a microchip, which makes it easier to identify the reagent composition of a contained solid-phase reagent.

According to an embodiment of the present disclosure, there is provided a microchip for chemical reaction in which a solid-phase reagent whose reagent composition can be identified based on appearance is contained.

At least two or more solid-phase reagents may be contained in a reaction area where a chemical reaction is carried out.

The reagent composition of the solid-phase reagent can be identified based on a shape and/or a color hue of the solid-phase reagent.

The reagent composition of the solid-phase reagent can be identified based on a peripheral portion and/or a surface portion of the solid-phase reagent.

The reagent composition of the solid-phase reagent can be identified based on a number of angles and/or sides of the peripheral portion.

The reagent composition of the solid-phase reagent can be identified by including a coloring agent.

The coloring agent may be a dye and/or a pH indicator.

The solid-phase reagent may have been frame molded or pressure molded.

The chemical reaction may be a nucleic acid amplification reaction, a hybridization reaction, a PCR extension reaction, or an antigen-antibody reaction.

According to an embodiment of the present disclosure, there is provided a method for fabricating a microchip for chemical reaction, including containing a solid-phase reagent whose reagent composition can be identified based on appearance.

At least two or more solid-phase reagents may be contained in a chemical reaction reaction area.

A solid-phase reagent may be contained that can be identified based on a shape and/or a color hue.

A solid-phase reagent may be contained whose reagent composition can be identified based on a peripheral portion and/or a surface portion.

A solid-phase reagent may be contained whose reagent composition can be identified based on a coloring agent.

A solid-phase reagent may be contained that has been frame molded or pressure molded.

According to an embodiment of the present disclosure, there is provided the method for fabricating a microchip for chemical reaction, including determining a reagent composition of the contained solid-phase reagent based on an appearance of the solid-phase reagent.

The appearance may be a shape and/or a color hue of the solid-phase reagent.

The reagent composition may be identified based on a number of angles and/or sides of the contained solid-phase reagent.

The reagent composition may be identified based on a coloring agent of the contained solid-phase reagent.

The chemical reaction may be a nucleic acid amplification reaction, a hybridization reaction, a PCR extension reaction, or an antigen-antibody reaction.

According to the embodiments of the present disclosure described above, there is provided a microchip for chemical reaction, and a method for fabricating such a microchip for chemical reaction, which makes it easier to identify the reagent composition of a contained solid-phase reagent.

### BRIEF DESCRIPTION OF THE DRAWINGS

FIG. 1 is a schematic view illustrating a configuration of a microchip 1 according to a first embodiment of the present disclosure;

FIG. 2 is a schematic view illustrating an example of a reagent R in a well 4 of the microchip 1;

FIG. 3 is a flowchart illustrating a fabrication method of the microchip 1;

FIG. 4 is a flowchart illustrating an identification method of a solid-phase reagent R contained in the microchip 1; and

FIG. 5 is a flowchart illustrating an identification method S4 of a solid-phase reagent R contained in the microchip 1 in the method for fabricating the microchip.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted. The description will be made in the following order.

1. Configuration of the microchip for chemical reaction according to a first embodiment of the present disclosure
2. Method for fabricating the microchip for chemical reaction according to a first embodiment of the present disclosure

### 1. Configuration of the Microchip for Chemical Reaction According to a First Embodiment of the Present Disclosure

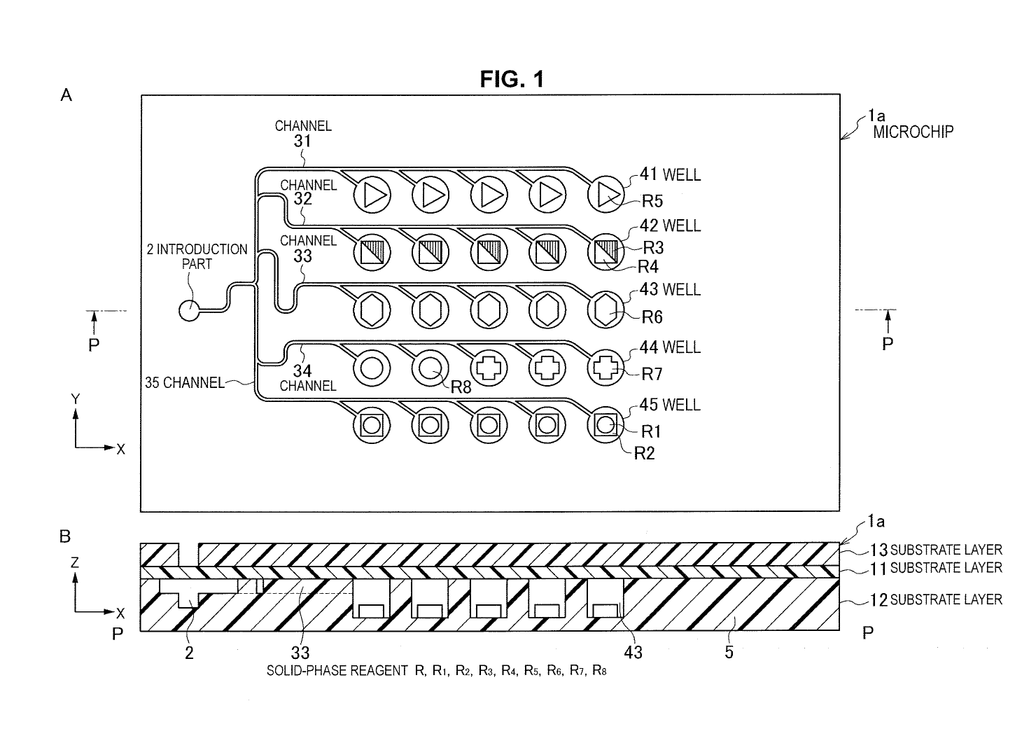

FIG. 1 is a schematic view illustrating a configuration of a microchip la according to a first embodiment of the present disclosure. FIG. 1A is a top face schematic view, and FIG. 1B is a cross-sectional schematic view across the P-P cross-section of FIG. 1A.

The microchip for chemical reaction (hereinafter sometimes also referred to as “microchip”) denoted by reference numeral 1a includes an introduction part 2, reaction areas 4 having a reaction site where a chemical reaction such as a nucleic acid amplification reaction is carried out, and channels 3 connecting the introduction part 2 and the respective reaction areas 4. As described below, a solid-phase reagent R that includes at least a part of the substances used in a chemical reaction, such as a nucleic acid amplification reaction, is contained in these reaction areas 4. Further, by providing in the reaction areas a partition through which fluid can move, a plurality of reaction sites can be provided where a chemical reaction such as a nucleic acid amplification reaction is carried out. For example, a solid-phase reagent that includes a reagent composition capable of detecting an intended detection target is contained in this plurality of reaction sites. Examples of the reagent composition include identical substances that specifically bind to or react with the intended detection target (an antigen antibody, a primer etc.). Consequently, even when a plurality of the same or different solid-phase reagents are contained in the same reaction area, bias among the solid-phase reagents in the reaction area is reduced, which makes it easier for the reagents to be uniformly dissolved during measurement.

With the above-described configuration, a fluid, such as a sample solution, can be externally introduced from the introduction part 2, and flowed through channels 31 to 35 into the respective reaction areas 4. Once the reagents have been dissolved by the fluid that has flowed in, a chemical reaction such as a nucleic acid amplification reaction is carried out, and measurement of the chemical reaction such as a nucleic acid amplification reaction is performed. During this measurement, desired light detection (e.g., fluorescence detection, turbidity detection, light transmittance detection etc.) can be performed by irradiating light on the reaction areas 4.

Note that in FIG. 1 and the description thereof, the plurality of reaction areas (hereinafter sometimes also referred to as “wells”) 4 supplied with sample solution by channel 31 are collectively referred to as well 41. Similarly, the respective plurality of wells 4 supplied with sample solution by channels 32, 33, 34, and 35 will be collectively described as wells 42, 43, 44, and 45. Further, the term sample solution refers to a solution that includes a nucleic acid such as DNA or RNA, which are a template nucleic acid that is the target of amplification in a nucleic acid amplification reaction.

Further, the long direction is defined as the direction in the X positive/negative direction, the short direction as the direction in the Y positive/negative direction, and the thickness direction as the direction in the Z positive/negative direction.

The “chemical reaction” carried out using the microchip according to an embodiment of the present disclosure is desirably a chemical reaction capable of chemical and biological analysis.

In this chemical reaction, any substance can serve as the measurement target, such as a chemical substance (physiologically active substance etc.), a protein, a peptide, DNA, RNA, an oligonucleotide, a polynucleotide, an antigen, an antibody, a microorganism, a virus, and a hormone, as well as a fragment of such substances. The measurement sample is desirably a sample related to the body, such as a cell, a culture, a nucleic acid amplification product, tissue, body fluid, urine, serum, a biopsy and the like.

The “chemical reaction” may be carried out using a known chemical reaction method capable of detection by reacting with the measurement target. Examples of the “chemical reaction” include a nucleic acid amplification reaction, a hybridization reaction between complementary nucleic acids, a PCR extension reaction, an antigen-antibody reaction and the like. Further, examples of the labeling method in the chemical reaction include, but are not limited to, a labeling method that uses one or two or more selected from a fluorescent substance, a radioactive substance, an enzyme and the like.

It is noted that “nucleic acid amplification reaction” includes a conventional PCR (polymerase chain reaction) that employs thermal cycling, as well as various isothermal amplification methods that do not involve thermal cycling. Examples of isothermal amplification methods include methods such as LAMP (loop-mediated isothermal amplification), SMAP (SMart Amplification Process), NASBA (nucleic acid sequence-based amplification), ICAN® (isothermal and chimeric primer-initiated amplification of nucleic acids), TRC (transcription-reverse transcription concerted), SDA (strand displacement amplification), TMA (transcription-mediated amplification), RCA (rolling circle amplification) and the like. In addition, the “nucleic acid amplification reaction” widely includes nucleic acid amplification reactions that are based on varying temperature or constant temperature, which are directed to the amplification of nucleic acids. Further, such nucleic acid amplification reaction also include reactions that involve quantification of an amplified nucleic acid, such as a real-time PCR method.

The solid-phase reagent R used in an embodiment of the present disclosure is contained in each well 4 so that the reagent composition can be identified based on its appearance. Consequently, reagent information included in the solid-phase reagent about, for example, the type of reagent (reaction reagent, detection reagent etc.) used in for the intended chemical reaction, the measurement target, and the chemical reaction conditions (reaction and detection method, reaction temperature, detection limits etc.) can be visually identified more easily.

It is noted that “can be visually identified” can also mean, in addition to being able to be identified by eyesight, that the shape and/or color hue of an object can be identified by an apparatus, such as an imaging apparatus.

Recently, since the number of measurement targets is tending to increase, users want a microchip for chemical reaction in which a reaction reagent matching the measurement target is contained in each well. Further, to improve operational efficiency, users also want a microchip for chemical reaction in which a different reaction reagent (especially a different primer) is contained in each well that enables them to measure a plurality of measurement targets together on the same chip. Thus, there is a necessity to provide a large number and a wide variety of types of microchip for chemical reaction according to the user's objective.

Further, to improve operational efficiency and reduce production costs, it is common to place the reagent solution in the well and let it dry, or for a solid-phase reagent having a shape close to that of the well to be contained in the well.

Consequently, to determine what kind of reagent composition the reaction reagents contained in the wells have, when fabricating the microchip it is common to use an indirect confirmation method, such as monitoring all the fabrication steps or appropriately changing the production line, for example. In addition, when used by the end user, this determination is performed by confirming the composition markings on the chip packaging container or the like. Therefore, in actual practice, there are cases in which a microchip containing a reaction reagent different to the intended measurement target is simply picked out by mistake.

In view of such circumstances, it is desirable to facilitate the identification of the reagent composition of the reaction reagents contained in the wells of the microchip during fabrication of a microchip for chemical reaction or when a user is going to use such a microchip.

Accordingly, although a solid-phase reagent contained in a well is typically made to have the same shape as the well, the present inventor focused on changing the appearance of the solid-phase reagent. This focus on changing the appearance enables the composition of the contained solid-phase reagent to be easily visually identified. Consequently, mistakes in the contained reaction reagent can be determined when enclosing the reaction reagent in the microchip. Although this change in the appearance of the reagent may seem to increase the work load, and thus cause operational efficiency to deteriorate, by enabling visual identification it is easier to confirm mistakes in containment, thereby improving operational efficiency and reducing production costs. Further, this also facilitates product quality management, so that quality is improved. In addition, since instances of the user taking the wrong microchip can also be visually confirmed, such mistakes can be reduced.

In addition, the production line or the reaction apparatus/analysis apparatus may be provided with an imaging device or an imaging unit, and a control unit that stores a program capable of identifying the reagent composition of the reaction reagent based on appearance and that can realize the identification method. Consequently, reagent information about a contained reaction reagent can be acquired, and the reagent composition can also be easily identified. Further, such matters can also be displayed to the manufacturer or the end user, for example. Still further, this also enables the various chemical reaction conditions of a nucleic acid amplification reaction or the like to be automatically set and carried out based on the acquired reagent information according to the contained reaction reagent.

It is preferred that the shape and/or the color hue of the above-described solid-phase reagent R can be visually identified.

The above-described solid-phase reagent R includes at least a part of the required substances that can react with and detect the measurement target.

Further, in the case of the nucleic acid amplification reaction according to an embodiment of the present disclosure, it is preferred that the solid-phase reagent R includes at least a part of the substances used to obtain an amplified nucleic acid strand. Specific examples include a component included in an oligonucleotide primer (hereinafter sometimes also referred to as “primer”), a nucleic acid monomer (dNTPs), an enzyme, and a reaction buffer solution that is complementary to at least a portion of the base sequence of the DNA, RNA and the like that is the amplification target. In addition, although not directly necessary in a nucleic acid amplification reaction, a probe including a label, such as a fluorescent label, for detecting the amplified nucleic acid strand, a detection reagent that intercalates with double-stranded nucleic acid and the like may also be included in the reagent R as a substance that is used for detection of an amplified nucleic acid strand.

It is noted that the solid-phase reagent R that can be employed for this nucleic acid amplification reaction can also be appropriately used in a hybridization reaction and an extension reaction.

Further, for the antigen antibody reaction according to an embodiment of the present disclosure, the solid-phase reagent R may include a reagent composition that can be used in an immunoassay technique. Examples of the immunoassay technique include a direct fluorescent-antibody technique in which an antibody that includes a fluorescent substance is bound to an antigen, an indirect fluorescent-antibody technique in which an antibody that includes a fluorescent substance is bound to an antibody the is bound to an antigen, an ELISA technique and the like. The ELISA technique may be a competitive technique, a sandwich technique, a direct absorption technique and the like. It is noted that for the antigen antibody reaction according to an embodiment of the present disclosure, if the intended measurement target is an antibody or the like, detection can be carried out with an antigen or a fragment thereof, for example, which includes a fluorescent substance that reacts with the intended measurement target. In addition, detection can also be carried out by using a chromogenic substrate in which a reaction substance obtained by reacting an antibody, an antigen or the like that is labeled with an enzyme with an enzyme produces a color.

The “shape” of the solid-phase reagent R that can be visually identified is not especially limited. The solid-phase reagent R preferably has a shape that can fit within the wells and that enables the reagent composition to be determined based on the shape of a peripheral portion, such as based on the number of angles and/or sides of the solid-phase reagent, or based on a surface portion, such as based on grooves or markings.

The term “angle” as used here refers to a portion formed when two lines or faces meet that points either outward or inward. This “angle” does not have to be a right angle. For example, the angle may be curved (have a radius), or have a star-shaped indented portion. Further, a “different shape” is desirably a shape that does not have the same shape when rotated or vertically flipped.

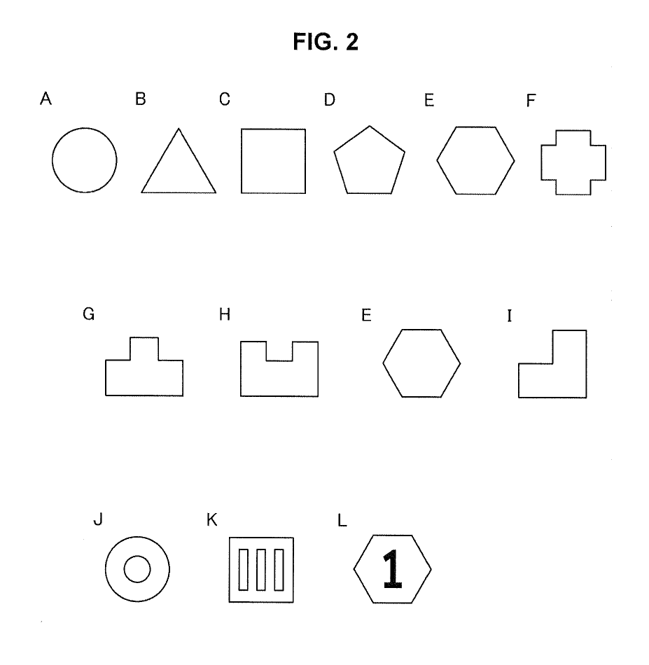

Examples of the shape of the above-described solid-phase reagent R are illustrated in FIG. 2 as A to I as viewed from the thickness direction.

Examples of the peripheral portion shape of the above-described solid-phase reagent R include circular, elliptical, semicircular, semi-elliptical, polygonal, L-shaped, T-shaped, U-shaped and the like. Examples of polygon shapes include triangular, square, pentagonal, hexagonal, star-shaped polygon and the like.

Thus, it is preferred to make the number of angles and/or sides of the solid-phase reagent R different, as this makes it easier to easily perform identification.

Further, one or a plurality of through holes or spaces that does not go all the way through may be formed on a surface (preferably the surface in the thickness direction) portion of the above-described solid-phase reagent R. Examples may include a doughnut-shaped reagent or a reagent having grooves on its surface, like those illustrated in FIGS. 2J and 2K. Further, as illustrated in FIG. 2L, a barcode, characters, numerals, symbols and the like may be formed on the surface of the reagent with marking or grooves.

Thus, pieces of information for identification that are different to each other can be provided on the peripheral portion and the surface portion. Further, since a large amount of identification information can be visually provided by selecting shapes having two or more different appearances from among the above examples and containing these reagents in the wells, the reagent composition, the reaction conditions and the like can be determined more easily.

The “color hue” of the solid-phase reagent R that can be visually identified is not especially limited. To adjust the color hue, it is preferred to include a coloring agent in the solid-phase reagent. Examples of this coloring agent may include a dye (food dye etc.), a pH indicator and the like. These can be used alone or in combination. Consequently, by containing a solid-phase reagent that has a color hue on its surface in the wells, the reagent composition, the reaction conditions and the like can be visually determined more easily.

In addition, by combining with the above-described shapes, the reagent can be provided with different information, namely, a color hue, which enables the reagent composition, the reaction conditions and the like to be visually determined even more easily. It is preferred to subject this solid-phase reagent to frame molding or pressure molding, as this makes it easy to adjust the shape and color hue.

Examples of the above-described dye may include, but are not limited to, the following substances.

| Exhibited Color | Dye |
|---|---|
| Red | Amaranth, Erythrosine, Allura Red AC, Phloxine, rose |
| | bengal, Acid red 52, New Coccine |
| Yellow | Tartrazine, Sunset Yellow FCF |
| Blue | Brilliant Blue FCF, Indigo carmine, Xylene cyanol FF |
| Green | Fast Green FCF |

Examples of the pH indicator may include, but are not limited to, the following substances.

| pH Indicator | Color Change Range |
|---|---|
| Chlorophenol Red | (Yellow)5.0-6.6(Red) |
| 4-Nitrophenol | (Slightly Yellow)5.0-7.6(Yellow) |
| Bromocresol Purple | (Yellow)5.2-6.8(Purple) |
| Bromophenol Red | (Yellow)5.2-6.8(Red) |
| Bromothymol Blue | (Yellow)6.0-7.6(Blue) |
| Bromoxylenol Blue | (Yellow)6.0-7.6(Blue) |
| Neutral Red | (Red)6.8-8.0(Yellow) |
| Pararosolic Acid | (Orange)6.8-8.0(Purplish red) |
| Phenol Red | (Yellow)6.8-8.4(Red) |
| 2-Nitrophenol | (Slightly Yellow)6.8-8.6(Yellow) |
| alpha-Naphtholphthalein | (Orange)7.0-8.6(Blue) |
| Cresol Red | (Yellow)7.2-8.8(Red) |
| m-Cresol Purple | (Yellow)7.4-9.0(Purple) |
| Ethyl Bis(2,4- | (Colorless)7.5-9.1(Blue) |
| dinitrophenyl)acetate | |
| Phenolphthalein | (Colorless)7.8-10.0(Rose pink) |
| Thymol Blue | (Yellow)8.0-9.6(Blue) |
| p-Xylenol Blue | (Yellow)8.0-9.6(Purple) |
| o-Cresolphthalein | (Colorless)8.0-9.8(Rose pink) |
| Thymolphthalein | (Colorless)8.6-10.5(Blue) |
| Mordant Orange 1 | (Yellowish orange)10.0-12.0(Orange red) |

The above-described coloring agent may be mixed in the solid-phase reagent prior to freeze-drying, or may be mixed in a powder after freeze-drying. Further, the coloring agent may be mixed with a reagent powder in a powdery state. In addition, the coloring agent may also be adhered to the surface of the solid-phase reagent R by dipping, spraying and the like.

Normally, for a dye that exhibits the same color hue, then the type of reagent that is contained in the wells of the microchip can be visually identified from that color hue. Consequently, the reagent composition, the reaction conditions and the like can be determined more easily.

Further, for a pH indicator, the conditions can be set so as to differentiate the pH between the state of the molded solid-phase reagent and the after the addition of the sample solution during measurement. Consequently, the fact that the sample solution has been charged into the microchip can be determined more easily.

In addition, for optical detection of a chemical reaction, such as a nucleic acid amplification reaction, it is desirable to select so that the wavelength absorbed by the coloring agent does not overlap the detection wavelength of the fluorescent dye that is used in the chemical reaction, such as a nucleic acid amplification reaction. The coloring agent can also be appropriately selected based on the fluorescent dye to be used.

Examples of the fluorescent dye may include, but are not limited to, the following substances.

| | Excitation | Detection |
|---|---|---|
| Fluorescent Dye | Wavelength (nm) | Wavelength (nm) |
| Pacific Blue | 400 | 450 |
| LightCycler Cyan 500 | 450 | 500 |
| YOYO-1 | 491 | 509 |
| BODIPY FL | 505 | 513 |
| Alexa488 | 495 | 520 |
| FITC | 495 | 530 |
| SYBR GreenI | 483 | 533 |
| FAM | 483 | 533 |
| Fluorescein | 483 | 533 |
| Rhodamine 6G | 520 | 555 |
| VIC/HEX | 523 | 568 |
| Pyronin Y | 540 | 570 |
| Rhodamine | 550 | 570 |
| TAMRA | 550 | 580 |
| x-rhodamine | 587 | 599 |
| LightCycler Red 610 | 483/558 | 610 |
| Texas red | 590 | 615 |
| LightCycler Red 640 | 483/558 | 640 |
| Cy5 | 615 | 670 |

For example, when using a fluorescent substance, such as Pacific Blue, LightCycler Cyan 50 and the like (detection wavelength of about 450 to 500 nm), for detection in the chemical reaction such as a nucleic acid amplification reaction, it is preferred to use a purple to blue coloring agent such as Brilliant Blue FCF, Indigo carmine, and Xylene cyanol FF.

Further, for example, when using a fluorescent substance, such as SYBR GreenI, BODIPY FL, FAM, Rhodamine and the like (detection wavelength of about 500 to 570 nm), for detection in the chemical reaction such as a nucleic acid amplification reaction, it is preferred to use a green coloring agent such as Fast Green FCF.

In addition, for example, when using a fluorescent substance, such as TAMRA, x-rhodamine, Texas red and the like (detection wavelength of about 570 to 620 nm), for detection in the chemical reaction such as a nucleic acid amplification reaction, it is preferred to use a yellow to orange coloring agent such as Tartrazine or Sunset Yellow FCF.

Still further, for example, when using a fluorescent substance, such as LightCycler Red 640, Cy5 and the like (detection wavelength of about 620 to 750 nm), for detection in the chemical reaction such as a nucleic acid amplification reaction, it is preferred to use a red coloring agent such as Amaranth, Erythrosine, Allura Red AC, Phloxine, rose bengal, Acid red 52, or New Coccine.

Further, when using a pH indicator, in the case of a LAMP method, for example, it is preferred to contain a solid-phase reagent whose color hue changes at a pH of about 8.8 (pH around 8.5 to 9.0). In such a case, it is preferred to use a plurality of solid-phase reagents, and adjust the pH of each reagent.

As one example, a PM reagent including a primer is prepared with a pH of 8.0 or less, and an RM reagent including Bst DNA polymerase is prepared with a pH of 8.8 or higher. Then, solid-phase reagents R1, R2, . . . are designed so that the pH after introducing the sample solution and mixing the PM reagent, the RM reagent, and the sample solution is about 8.8. Consequently, the pH indicator included in the PM reagent causes the color hue to change based on a change in the pH.

For example, a PM reagent prepared with a pH of 7.5 and that includes Thymol Blue as an indicator will exhibit a yellow color. This yellow PM reagent and an RM reagent prepared with a pH of 8.8 by using Tris-HCl, for example, are mixed together to produce solid-phase reagents R1 and R2, which are contained in the microchip wells. Consequently, the reagent composition, the reaction conditions and the like can be determined more easily.

By introducing the sample solution, the sample mixes with the PM reagent and the RM reagent in the wells. When the pH in the wells reaches 8.8, the Thymol Blue included in the PM reagent turns green. Consequently, the fact that the sample solution has been injected into the microchip can be determined more easily.

At this stage, it is preferred to use a fluorescent dye for LAMP method detection, such as BODIPY FL, SYBR GreenI and the like (detection wavelength of about 500 to 570 nm), because such a fluorescent dye is less likely to hinder optical detection.

As another example, a PM reagent including a primer and/or an RM reagent including Bst DNA polymerase is/are prepared with a pH of 7.5 or less or a pH of 9.5 or higher. Then, solid-phase reagents R1, R2, . . . are designed so that the pH after introducing a basic or an acidic sample solution and mixing the PM reagent, the RM reagent, and the sample solution is about 8.8. Consequently, the pH indicator included in the PM reagent causes the color hue to change based on a change in the pH.

For example, when a PM reagent and an RM reagent are prepared using Tris-HCl so as to have a pH of 7.5, and Thymol Blue is included as an indicator, the PM reagent will exhibit a yellow color.

When a basic sample solution is introduced, the sample mixes with the PM reagent and the RM reagent in the wells, and when the pH in the wells reaches 8.8, the Thymol Blue included in the PM reagent turns green.

Further, when a PM reagent and an RM reagent are prepared using Tris-HCl so as to have a pH of 9.5, and Thymol Blue is included as an indicator, the PM reagent will exhibit a blue color.

When an acidic sample solution is introduced, the sample mixes with the PM reagent and the RM reagent in the wells, and when the pH in the wells reaches 8.8, the Thymol Blue included in the PM reagent turns green.

Thus, by adjusting the color hue of the solid-phase reagent (e.g., adjusting the color hue by coloring with a coloring agent etc.), the composition of the solid-phase reagent can be determined more easily during production, and the reagent arrangement in the microchip can also be confirmed more easily. Further, the mixing state of the reagents when injecting the sample solution into the microchip can also be easily confirmed.

Further, the concentration of the included coloring agent can be visually recognized. This concentration is not especially limited, as long as it does not hinder the chemical reaction such as a nucleic acid amplification reaction. The ultimate concentration in the microchip wells for the chemical reaction such as a nucleic acid amplification reaction is preferably 0.01 to 0.0001 mass %. However, the concentration is not limited to this.

In addition, it is preferred that at least two or more of the above-described solid-phase reagents R are contained in the reaction areas of the chemical reaction such as a nucleic acid amplification reaction. In such a case, as illustrated in well 45 of FIG. 1, solid-phase reagents R1 and R2 may be stacked in a thickness direction in each well 4. Further, as illustrated in well 42 of FIG. 1, a plurality of solid-phase reagents R3 and R4 may be arranged in a planar direction in each well 4. It is noted that the microchip according to an embodiment of the present disclosure can carry out a chemical reaction, such as a nucleic acid amplification reaction, and detection at a reaction site of the chemical reaction, such as a nucleic acid amplification reaction. By carrying out the reaction and the detection at the same site, the accuracy of the real-time measurement is good.

Still further, it is preferred that a plurality of solid-phase reagents having the same reagent composition or solid-phase reagents having different reagent compositions are contained in the reaction areas. This enables reagent information included in the solid-phase reagent about, for example, the type of reagent (reaction reagent, detection reagent etc.) used in the intended chemical reaction, the measurement target, and the chemical reaction conditions (reaction method, detection method, reaction temperature, detection limits etc.) to be visually identified more easily. Further, for a reaction that uses a primer, such as a nucleic acid amplification reaction, the type of primer included in the solid-phase reagent, the measurement target, and the nucleic acid amplification reaction conditions (amplification method, reaction temperature, detection limits etc.) can be visually identified more easily. In addition, the state of progress of the reaction during measurement can also be visually identified more easily based on changes in the color hue of the solution according to the combination of two or more reagents.

Regarding the number of primers used in the solid-phase reagents according to an embodiment of the present disclosure, it is noted that primers including a different base sequence to a primer formed from a given base sequence are counted as a different type of primer even if they are a primer set.

When containing a plurality of the above-described solid-phase reagents R in one reaction area, to carry out a single chemical reaction such as a nucleic acid amplification reaction, solid-phase reagents R1, R2, . . . may be arranged by dividing the components of the reagent composition that are used in the chemical reaction, such as a nucleic acid amplification reaction, among two or more reagents.

For example, it is desirable to split up the respective components that cause the reaction to occur when combined, prepare so that two or more solid-phase reagents are formed, like solid-phase reagents R1, R2, . . . , and then place the prepared solid-phase reagents in the same well serving as the reaction site.

For a nucleic acid amplification reaction, a solid-phase reagent R1 that includes a primer but does not include an enzyme and a solid-phase reagent R2 that includes an enzyme but does not include a primer can be prepared and contained in the same well, which serves as the reaction site.

Consequently, since the two or more reagents are not mixed until the sample solution is introduced into the well, the occurrence of by-products due to mixing can be suppressed, thereby enabling highly accurate analysis to be performed. For example, examples of by-products include a primer dimer that is produced when an enzyme and a dimer are mixed. However, by splitting up the two or more reagents, non-specific amplification of nucleic acids due to the primer dimer is suppressed, which enables highly accurate analysis to be performed.

When containing a plurality of the above-described solid-phase reagents R in one reaction site, to detect a plurality of measurement targets, two or more types of solid-phase reagents having different reagent compositions may be arranged. This facilitates visual identification of the type of target that the target is. It is noted that to suppress the occurrence of by-products, the reagent composition may be split up into the primer and the enzyme, for example.

Normally, when a plurality of solid-phase reagents are contained in a well, it is difficult to understand what kind of reagent composition these reagents have. In contrast, by using the solid-phase reagent according to an embodiment of the present disclosure, it is easy to visually identify what kind of reagent composition the reagents are formed from. Further, according to an embodiment of the present disclosure, even if a plurality of reagents are present, the reagents can be identified from the thickness direction of the microchip (e.g., from above or below). This enables the reagent composition to be identified by eyesight, so that by including in advance in a control unit a program for determining the reagent composition, the reaction conditions and the like, the reagent composition, the reaction conditions and the like can also be determined during microchip fabrication or during the chemical reaction, such as a nucleic acid amplification reaction.

The solid-phase reagent R used in an embodiment of the present disclosure can be produced by, for example, drying the reagent solution into a solid and then molding, or molding from the reagent raw materials that are in a powder.

Examples of a preferred drying method include freeze-drying. Further, it is preferred that the freeze-drying includes steps such as pre-freezing, primary drying (sublimation freezing), and secondary drying (removal of bound water).

The pre-freezing can be carried out if the freezing temperature is at the eutectic point (temperature at which the reagent solution freezes) or lower. However, in order to prevent enzyme deactivation and completely freeze the reagent solution, it is preferred to freeze at about −40° C. In the primary drying, the reagent solution frozen in the pre-freezing step is dried. At this point, dissolution during the drying process can be prevented and the moisture included in the reagent solution can be sublimed by drying the reagent solution at the eutectic point or lower. The degree of vacuum in the primary drying is desirably 100 Pa or less, for example. The boiling point of water at 100 Pa is about −20° C., which is close to the above-described eutectic point of the reagent solution. Accordingly, dissolution during the drying process is prevented. The degree of vacuum in the primary drying can be appropriately selected based on the eutectic point of the prepared reagent solution. In the secondary drying, water in a molecular state that is adhered to the components included in the reagent solution after the primary drying is removed. The reagent solution can be heated to a temperature at which the components in the reagent solution are not deactivated, denatured or the like, to increase the degree of dryness of the reagent solution.

Further, after freeze-drying, the reagent may be compressed by applying pressure with a tableting machine, for example, to a level at which the rate of dissolution is not decreased.

To carry out molding while maintaining solubility, additives that are commonly used in a tablet may be added to the reagent solution, such as an excipient, a disintegrating agent, a binder, and a lubricant. Examples of the excipient include D-mannitol, glycerin, lactose, starch, dextrin, white sugar, crystalline cellulose and the like. Examples of the binder include starch paste and hydroxypropyl cellulose and the like. Examples of the disintegrating agent include crospovidone, carmellose, carmellose calcium, hydroxypropyl cellulose, crystalline cellulose, powdered cellulose, corn starch, xylitol and the like. Examples of the lubricant include magnesium stearate and the like. It is preferred that these additives do not influence the chemical reaction such as a nucleic acid amplification reaction.

Further, the solid-phase reagent R may also be molded with a tableting machine, for example, from a reagent that has been turned into a powder.

Examples of the method for turning into a powder include fluidized bed granulation, high-speed agitation granulation, dry granulation, spray drying, freeze-drying and the like. The molding of the powder may be carried out by a tableting method or a molding method. When turned into a powder, it is desirable to admix the above-described additives that are commonly used in a tablet into the reagent that includes at least a substance used in for the chemical reaction, such as a nucleic acid amplification reaction.

In a direct tableting method, a fixed amount is placed on a template that has a flat shape different to those described above, and the powder is turned into a solid by applying an optimum pressure. To maintain solubility even after solidification, the above-described excipient, disintegrating agent, a sugar and the like may be added.

In a molding method, a mixed powder including the drug is granulated with water or a water/alcohol binder, and is tableted under low pressure while still moist. Then, the solvent is evaporated to increase the number of pores.

Note that, as illustrated by wells 41 and 43 in FIG. 1, all of the wells in the well group may have a solid-phase reagent R5 or R6 with the same appearance, or as illustrated by well 44, each of the wells 4 may have a different solid-phase reagent R7 or R8. Consequently, cases can be handled in which there is an increased number of specimens for the same measurement target or in which there is a large number of different measurement targets.

Further, as illustrated by well 45 of FIG. 1, solid-phase reagents R1 and R2 having a different shape may be stacked and contained in the wells 4. In addition, as illustrated by well 42, solid-phase reagents R3 and R4 having a different color hue may be contained in the wells 4 by arranging them in a planar direction. Still further, solid-phase reagents R1, R2, R3, R4, . . . having a different color hue and/or shape may be arranged in the wells in a thickness direction and/or planar direction. Consequently, cases can be handled in which a plurality of measurement targets are to be measured, or in which detailed conditions are set based on the measurement target. It is noted that although in FIG. 1 the reagents are denoted for convenience as solid-phase reagents R1, R2, R3, R4, . . . , the appearance of the solid-phase reagent R is not limited by this.

The microchip 1a is formed by bonding a substrate layer 11 on a substrate layer 12 on which the introduction part 2, the channels 31 to 35, and the wells 41 to 45 are formed, and then bonding a substrate layer 13 on the substrate layer 11 (refer to FIG. 1B). In the microchip 1a, if the bonding of the substrate layer 11 and the substrate layer 12 is carried out under a pressure lower than atmospheric pressure, the interior of the introduction part 2, the channels 31 to 35, and the wells 41 to 45 can be hermetically sealed at a pressure lower than atmospheric pressure (1/100 atmospheric pressure). In the microchip 1a, by making the area into which the sample solution is introduced have a pressure lower than atmospheric pressure, the sample solution is sucked up due to the negative pressure inside the microchip when the sample solution is introduced. Consequently, the introduction of the sample solution into the microchip 1a in which micro channel structures are formed can be carried out in a shorter period of time.

Examples of the material of the substrate layers 11, 12, and 13 include glass and various kinds of plastic. Preferably, the substrate layers 12 and 13 are formed from a gas-impermeable material. By using a gas-impermeable material, such as PC, for the substrate layers 12 and 13 that form the outer face of the microchip 1a, the sample solution introduced into the wells 41 to 45 can be prevented from being turned into a gas by the heat of the chemical reaction, such as a nucleic acid amplification reaction, and escaping (fluid loss) through the substrate layer 11. Further, when the area of the microchip 1a into which the sample solution is introduced is hermetically sealed due to having a lower pressure than atmospheric pressure, it is also preferred that the substrate layers 12 and 13 is formed from a gas-impermeable material in order to prevent the entry of air from outside of the microchip 1a to maintain the internal negative pressure.

Examples of the material forming the gas-impermeable substrate layers includes glass, plastics, metals, and ceramics. Examples of plastics include PMMA (polymethyl methacrylate acrylic resin), PC (polycarbonate), PS (polystyrene), PP (polypropylene), PE (polyethylene), PET (polyethylene terephthalate), diethylene glycol bis-allyl carbonate, SAN resin (styrene-acrylonitrile copolymer), MS resin (MMA-styrene copolymer), TPX (poly(4-methyl penten-1)), polyolefin, SiMA (siloxanyl methacrylate monomer)-MMA copolymer, SiMA-fluorine containing monomer copolymer, silicon macromer-(A)-HFBuMA (heptafluorobutyl methacrylate)-MMA terpolymer, disubstituted polyacetylene-based polymer and the like. Examples of metals include aluminum, copper, stainless steel (SUS), silicon, titanium, tungsten and the like. Examples of ceramics include alumina (Al2O3), nitrogen aluminum (AlN), silicon carbide (SiC), titanium oxide (TiO2), zirconia oxide (ZrO2), quartz and the like.

The substrate layer 11 is preferably formed from an elastic material. In the microchip 1a, by forming the substrate layer 11 that seals the introduction part 2 from an elastic material, a portion of a penetrating member, such as a needle, can penetrate the introduction part 2 from outside the microchip 1a. If a syringe connected to the needle is pre-filled with the sample solution, and the substrate layer 11 is penetrated by that needle, the sealed introduction part 2 and the interior of the syringe are connected, and the sample solution can be introduced into the microchip 1a without air bubbles being formed.

Further, when the area into which the sample solution is introduced is hermetically sealed by having a lower pressure than atmospheric pressure, at the point when the tip of the needle reaches the introduction part 2, due to the pressure difference between outside the microchip 1a and the introduction part 2, the sample solution in the syringe is automatically sucked into the introduction part 2.

By forming the substrate layer 11 from an elastic material, when the needle is withdrawn from the introduction part 2 after the sample solution has been introduced, the penetrated location can be naturally sealed due to the self-sealing ability of the substrate layer 11. In an embodiment of the present disclosure, natural sealing of the penetrated location of the needle due to elastic deformation of the substrate layer is defined as “self-sealing ability”.

Examples of the elastic material includes acrylic-based elastomer, urethane-based elastomer, fluorine-based elastomer, styrene-based elastomer, epoxy-based elastomer, and natural rubber, in addition to silicon-based elastomer such as polydimethylsiloxane (PDMS).

Note that, in the case of optically analyzing the substances held in each well of the microchip 1a according to an embodiment of the present disclosure, it is preferred to select as the material for each of the substrate layers a material that is light transmissive and that has little optical error due to having little intrinsic fluorescence and a small wavelength dispersion.

### 2. Method for Fabricating the Microchip for Chemical Reaction According to a First Embodiment of the Present Disclosure

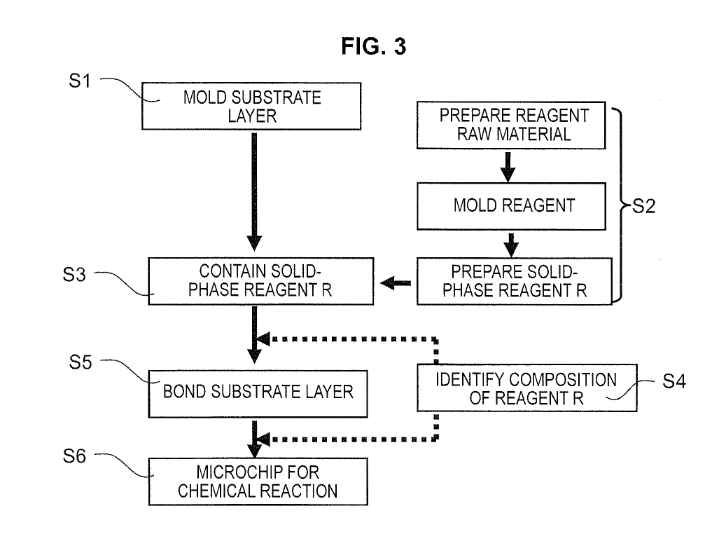

The method for fabricating the microchip 1a will now be described with respect to the flowchart illustrated in FIG. 3. The fabrication method according to an embodiment of the present disclosure includes containing the solid-phase reagent R and bonding a substrate layer. The solid-phase reagent R to be contained may be prepared in advance and then contained, or may be contained by preparing in the well portions of the substrate layer. However, the former case is preferred, as it is easier to adjust the shape and color hue of the solid-phase reagent as desired.

Further, it is preferred to identify the reagent composition from the appearance of the solid-phase reagent R present in the reaction area after the containing or bonding. Consequently, a determination can be made regarding whether there is a mistake in the contained reagent.

Based on the above-described processes, the microchip for chemical reaction according to an embodiment of the present disclosure can be obtained.

It is noted that the following description will be made in order of molding the substrate layer, preparing the solid-phase reagent R, containing the solid-phase reagent R, and bonding the substrate layer. However, the present disclosure is not limited to this order, as long as the molding of the substrate layer and the preparation of the solid-phase reagent R can be carried out before containing.

### (1) Molding of the Substrate Layer

In FIG. 3, reference symbol S1 represents a step of molding the substrate layer. In step S1, the introduction part 2, channels 31 to 35, and wells 41 to 45 are formed on the substrate layer 12. The molding of the introduction part 2 and the like onto the substrate layer 12 can be carried out by a known technique. For example, the molding can be carried out by wet etching or dry etching of a glass substrate layer, or by nano-printing, injection molding, or cutting of a plastic substrate layer. Further, the substrate layer 12 and the like can be molded on the substrate layer 11, or some parts may be molded on the substrate layer 11, and the remaining parts molded on the substrate layer 12.

### (2) Preparation of the Solid-Phase Reagent

In FIG. 3, reference symbol S2 represents a step of preparing the solid-phase reagent R. Step S2 includes preparation of the reagent raw material and solidifying and molding of the reagent. Examples of preparation of the reagent raw material include preparing a reagent solution, preparing a reagent powder and the like. Further, examples of solidifying and molding of the reagent include performing freeze-drying/frame molding, performing pressure molding and the like.

### (i) Preparation of the Reagent Raw Material

(i-a) For preparation of the reagent raw material, a liquid or a gel-like reagent solution is prepared based on the composition of the reagent R to be contained in the microchip 1a. It is sufficient if the reagent solution only includes at least a part of the substances that are used in the chemical reaction, such as a nucleic acid amplification reaction. Further, the above-described coloring agent, excipient, binder, disintegrating agent, lubricant and the like may also be included. It is preferred that the reagent solution as well as the primer solution and enzyme solution to be added to the reagent solution are stored at a low temperature.
(i-b) For preparation of the reagent powder, the above-described prepared reagent may be dried, for example, and turned into a powder, or various raw materials (coloring agent, excipient, binder, disintegrating agent, lubricant etc.) in powder form may be mixed to form a powder.

### (Ii) Molding of the Reagent

Molding of the reagent is not especially limited, as long as the reagent can be molded into a desired shape. However, frame molding and pressure molding are preferred.

(ii-a) In drying/frame molding, it is preferred to produce the reagent R, which is in a solid state and can be identified based on its appearance, according to an embodiment of the present disclosure by placing the reagent solution prepared as described above in a frame mold for solidification and drying. It is preferred that the material of this frame mold for solidification can withstand the below-described drying.

Drying/frame molding includes the dropwise addition of the above-described reagent solution into the frame mold for solidification, and the drying of the reagent solution in that frame mold. Further, in order to form into a desired shape after the freeze-drying, drying/frame molding may also include performing pressure molding.

Examples of the drying method include, but are not especially limited to, air drying, heated drying, freeze-drying and the like. Among these, freeze-drying is preferred, because the reagent is less likely to be denatured. Further, it is preferred that the freeze-drying includes steps such as pre-freezing, primary drying (sublimation freezing), and secondary drying (removal of bound water). The pre-freezing can be carried out if the freezing temperature is at the eutectic point (temperature at which the reagent solution freezes) or lower. However, in order to prevent enzyme deactivation and completely freeze the reagent solution, it is preferred to freeze at about −40° C. In the primary drying, the reagent solution frozen in the pre-freezing step is dried. At this point, dissolution during the drying process can be prevented and the moisture included in the reagent solution can be sublimed by drying the reagent solution at the eutectic point or lower. The degree of vacuum in the primary drying is desirably 100 Pa or less, for example. The boiling point of water at 100 Pa is about −20° C., which is close to the above-described eutectic point of the reagent solution. Accordingly, dissolution during the drying process is prevented. The degree of vacuum in the primary drying can be appropriately selected based on the eutectic point of the prepared reagent solution. In the secondary drying, water in a molecular state that is adhered to the components included in the reagent solution after the primary drying is removed. The reagent solution can be heated to a temperature at which the components in the reagent solution are not deactivated, denatured or the like, to increase the degree of dryness of the reagent solution.

Then, the solid-phase reagent R formed in the frame mold for solidification is removed from the frame.

(ii-b) Powder/Pressure Molding

It is preferred to produce the reagent R, which is in a solid state and can be identified based on its appearance, according to an embodiment of the present disclosure by appropriately incorporating the above-described coloring agent and additives commonly used in a tablet in the reagent prepared as described above, forming the resultant mixture into a powder, and then pressure molding.

### (3) Containing the Solid-Phase Reagent

In FIG. 3, reference symbol S3 represents a step of containing the solid-phase reagent R according to an embodiment of the present disclosure. In step S3, one or a plurality of solid-phase reagents R is/are contained in the wells 4, which are reaction sites formed during molding of the substrate layer. Here, a plurality of solid-phase reagents R, R2, . . . can be contained in a single well. The solid-phase reagent R according to an embodiment of the present disclosure is as described above in “1. Configuration of the microchip for chemical reaction according to a first embodiment of the present disclosure”.

### (4) Identification of the Solid-Phase Reagent Composition

In FIG. 3, reference symbol S4 represents a step of visually identifying the solid-phase reagent R based on appearance. This visual identification can identify the composition of the reagent by, for example, confirming by eyesight or with an imaging apparatus or the like. The definition of the appearance (shape and color hue) of the solid-phase reagent R according to an embodiment of the present disclosure is as described above in “1. Configuration of the microchip for chemical reaction according to a first embodiment of the present disclosure”.

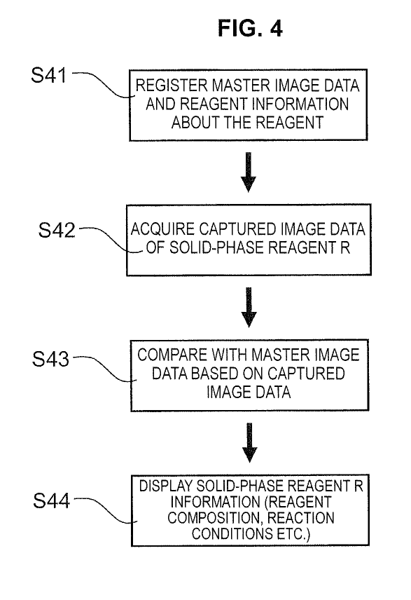

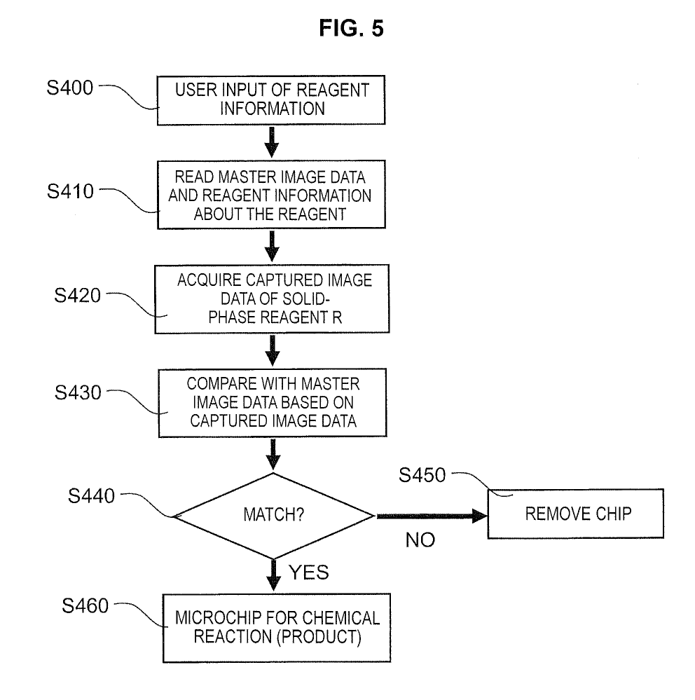

The method for identifying the reagent composition of the solid-phase reagent R and the method for acquiring this reagent information will be described with respect to FIGS. 4 and 5. However, the present disclosure is not limited to this. Further, this identification method and acquisition method may be used in methods other than a microchip fabrication method.

Captured image data of the solid-phase reagent R contained in the wells 4 of the microchip can be acquired with an imaging apparatus or the like. When identifying the reagent composition based on this captured image data, the image data that acts as a master for the appearance (shape and/or color hue) of the solid-phase reagent R and reagent information about the solid-phase reagent R are registered in advance in a storage unit and the like (S41). The image data that acts as a master for the reagent shape and reagent color hue and the reagent information may be separately registered and combined as necessary by a control unit or the like.

It is noted that the reagent information is as described above in “1. Configuration of the microchip for chemical reaction according to a first embodiment of the present disclosure”. As described above, for a nucleic acid amplification reaction, examples of such reagent information may include the type of primer included in the solid-phase reagent, the measurement target, and the nucleic acid amplification reaction conditions (amplification method, reaction temperature, detection limits etc.).

Further, before bonding the substrate layer, an image of the solid-phase reagent R contained in each well is captured with the imaging apparatus, and the captured image data of each solid-phase reagent R is acquired (S42). This captured image data is compared with the registered master image data (S43). Reagent information corresponding to the master image data that was found to be a match is extracted, and is used as the reagent information about each of the contained solid-phase reagents R. Based on this information, the reagent composition and the like of each contained solid-phase reagent R is identified (S44).

When identifying the reagent composition and the like based on the shape of the contained solid-phase reagent R, the identification is performed based on the shape of the peripheral portion of the reagent, such as the number of angles and/or sides of the reagent, or based on the shape of a marking, a groove or the like on the surface portion of the reagent. A search is made for captured image data whose shape matches the shape of the registered master image data, and the reagent information and the like corresponding to that master image data is extracted. Then, that reagent information is displayed on a monitor or the like as the reagent composition of the solid-phase reagent R.

When identifying based on the color hue of the contained solid-phase reagent, the identification is performed based on the color hue of the reagent surface. A search is made for captured image data whose color hue matches the color hue of the registered master image data, and the reagent information and the like corresponding to that master image data is extracted. Then, that reagent information is displayed on a monitor or the like as the reagent composition of the solid-phase reagent R.

Further, based on the shape and color hue of the captured image data, and the shape and color hue of the registered master image data, reagent information corresponding to both the shape and the color hue of that master image data may be extracted. The respective pieces of reagent information may be combined by a control unit and the like, and displayed as the reagent composition of the solid-phase reagent R.

Based on this determination result, the reagent information can also be printed or recorded on the substrate surface of the microchip, the container in which the microchip is packaged, an instruction manual and the like.

Further, when performing product quality management and the like during fabrication of the microchip, the user inputs in advance input information into a determination apparatus and the like (S400), and based on this input information, the reagent information corresponding to that is read (S410).

Examples of this input information include the appearance (shape and/or color hue) of a predetermined solid-phase reagent to be contained when fabricating a microchip for chemical reaction, the reagent composition corresponding to a solid-phase reagent and the like. Further, this input information can also be appropriately set for each well or well group. In addition, based on the information input by the user, reagent information matching the input information from the registered master data can also be added.

An image of the solid-phase reagent R contained in the well is captured, and this captured image data is acquired (S420). Based on this captured image data, a comparison with the read master image data is performed based on the information input by the user (S430). A determination is then made based on the information input by the user regarding whether the appearance of the reagent matches the appearance of the reagent in the captured image data (S440).

If it is determined that the appearance of the reagent in the input information does not match the appearance of the reagent in the captured image data (NO), the subject solid-phase reagent is determined as not being contained in the well. Then, this microchip is removed from the fabrication line without performing the below-described bonding (S450).

On the other hand, if it is determined that the appearance of the reagent in the input information matches the appearance of the reagent in the captured image data (YES), the subject solid-phase reagent is determined as being contained in the well. Then, the below-described bonding is performed to obtain the microchip for chemical reaction according to an embodiment of the present disclosure (S460).

It is noted that although the above-described determination regarding whether there is a match for the contained solid-phase reagent R or not can be performed after the substrate has been bonded or after the microchip has been packaged, from the perspectives of improving fabrication costs and operational efficiency, it is desirable to perform this determination after the solid-phase reagent is contained in the well, before the substrate is bonded.

Further, the above-described identification and acquisition method and procedure can also be stored as a program in a hardware resource having a control unit that includes a CPU, a RAM, a ROM and the like, and a storage medium (USB memory, HDD, CD etc.), and this program can be executed by the control unit, for example. In addition, by incorporating the above-described identification and acquisition method and procedure in a microchip for chemical reaction detection apparatus, fabrication line or the like, the microchip for chemical reaction according to an embodiment of the present disclosure can be efficiently fabricated.

### (5) Bonding of the Substrate Layer

In FIG. 3, reference symbol S5 represents a step of bonding a substrate layer.

In step S5, another substrate layer is bonded on either of the substrate layers in which the solid-phase reagent R was contained. The bonding of the substrate layers 11, 12, and 13 can be performed by a known method, such as thermal fusion bonding, with an adhesive, anodic bonding, bonding using a pressure-sensitive adhesive sheet, plasma activation bonding, ultrasonic bonding and the like. Further, by carrying out the bonding of the substrate layers 11, 12 and 13 under a pressure lower than atmospheric pressure, the respective areas of the introduction part 2, the channels 31 to 35, and the wells 41 to 45 into which the sample solution is introduced can be made to have a pressure lower than atmospheric pressure (e.g., 1/100 atmospheric pressure). When a material, such as PDMS, that in addition to being elastic is also impermeable to gases, is used for the substrate layer 11 that seals the wells 41 to 45, if these layers are left under a negative pressure (vacuum) after the substrate layers 11 and 12 have been bonded, the air that is present in the respective areas, such as the introduction part 2, passes through the substrate layer 11. Consequently, the interior of the microchip 1a can be made to have a pressure lower than atmospheric pressure (a vacuum). It is noted that the step of making the interior of the microchip 1a have a pressure lower than atmospheric pressure is not a necessary step in the method for fabricating the microchip according to an embodiment of the present disclosure.

Further, it is preferred that an apparatus, such as a nucleic acid amplification reaction apparatus, a nucleic acid hybridization apparatus, an antigen-antibody reaction detection apparatus a light detection apparatus, an analyzer and the like have an imaging unit and a control unit for controlling the imaging unit in a coordinated manner with the appearance of the solid-phase reagent R contained in the wells of the microchip for chemical reaction according to an embodiment of the present disclosure. In addition, the identification and acquisition method and procedure described in “(4) Identification of the solid-phase reagent composition” can be stored as a program in a hardware resource, such as a nucleic acid amplification reaction apparatus or a light detection apparatus, that has a control unit, a storage medium and the like, and this program can be executed by the control unit. This control unit at least has a CPU, and optionally also has a RAM, a ROM and the like. Examples of the storage medium include, but are not especially limited to, a USB memory, a HDD, a CD and the like.

The above-described “(4) Identification of the solid-phase reagent composition” is thus performed by setting the microchip in an apparatus, such as a reaction apparatus or an analyzer, and capturing an image (e.g., FIGS. 4 and 5). Then, the reagent information about the solid-phase reagent R contained in each well is read, this reagent information is set in the control unit and the storage unit of the apparatus, and the reaction or analysis is carried out. The reagent information is as described above in “1. Configuration of the microchip for chemical reaction according to a first embodiment of the present disclosure”. As described above, for a nucleic acid amplification reaction, examples of such reagent information may include the type of primer included in the solid-phase reagent, the measurement target, and the nucleic acid amplification reaction conditions (amplification method, reaction temperature, detection limits etc.).

Consequently, the user does not have to input troublesome reaction conditions. Further, since the kind of chemical reaction (e.g., a nucleic acid amplification reaction etc.) performed by the apparatus is displayed on a display or the like, even if the user does not perform a visual confirmation, instances in which the user takes the wrong chip can be reduced.

Additionally, the present technology may also be configured as below.

(1) A microchip for chemical reaction in which a solid-phase reagent whose reagent composition can be identified based on appearance is contained.
(2) The microchip for chemical reaction according to (1), wherein at least two or more solid-phase reagents are contained in a reaction area where a chemical reaction is carried out.
(3) The microchip for chemical reaction according to (1) or (2), wherein the reagent composition of the solid-phase reagent can be identified based on a shape and/or a color hue of the solid-phase reagent.
(4) The microchip for chemical reaction according to any one of (1) to (3), wherein the reagent composition of the solid-phase reagent can be identified based on a peripheral portion and/or a surface portion of the solid-phase reagent.
(5) The microchip for chemical reaction according to (4), wherein the reagent composition of the solid-phase reagent can be identified based on a number of angles and/or sides of the peripheral portion.
(6) The microchip for chemical reaction according to any one of (1) to (5), wherein the reagent composition of the solid-phase reagent can be identified by including a coloring agent.
(7) The microchip for chemical reaction according to (6), wherein the coloring agent is a dye and/or a pH indicator.
(8) The microchip for chemical reaction according to any one of (1) to (7), wherein the solid-phase reagent has been frame molded or pressure molded.
(9) The microchip for chemical reaction according to (3), wherein the chemical reaction is a nucleic acid amplification reaction, a hybridization reaction, a PCR extension reaction, or an antigen-antibody reaction.
(10) A method for fabricating a microchip for chemical reaction, including containing a solid-phase reagent whose reagent composition can be identified based on appearance.
(11) The method for fabricating a microchip for chemical reaction according to (10), wherein at least two or more solid-phase reagents are contained in a chemical reaction reaction area.
(12) The method for fabricating a microchip for chemical reaction according to (10) or (11), wherein a solid-phase reagent is contained that can be identified based on a shape and/or a color hue.
(13) The method for fabricating a microchip for chemical reaction according to (12), wherein a solid-phase reagent is contained whose reagent composition can be identified based on a peripheral portion and/or a surface portion.
(14) The method for fabricating a microchip for chemical reaction according to (12), wherein a solid-phase reagent is contained whose reagent composition can be identified based on a coloring agent.
(15) The method for fabricating a microchip for chemical reaction according to (12), wherein a solid-phase reagent is contained that has been frame molded or pressure molded.
(16) The method for fabricating a microchip for chemical reaction according to (12), including determining a reagent composition of the contained solid-phase reagent based on an appearance of the solid-phase reagent.
(17) The method for fabricating a microchip for chemical reaction according to (16), wherein the appearance is a shape and/or a color hue of the solid-phase reagent.
(18) The method for fabricating a microchip for chemical reaction according to (17), wherein the reagent composition is identified based on a number of angles and/or sides of the contained solid-phase reagent.
(19) The method for fabricating a microchip for chemical reaction according to (17), wherein the reagent composition is identified based on a coloring agent of the contained solid-phase reagent.
(20) The method for fabricating a microchip for chemical reaction according to (12), wherein the chemical reaction is a nucleic acid amplification reaction, a hybridization reaction, a PCR extension reaction, or an antigen-antibody reaction.

### EXAMPLES

The present technology will now be described in more detail with reference to the following examples. However, the present technology is not limited to these examples.

### <Method for Molding Solid-Phase Reagent>

1) Molding from Solution Dispensing: Solution Dispensing→Freeze-Drying→(Tableting)

Freeze-drying was used as the solidification method. The freeze-drying includes the steps of pre-freezing, primary drying (sublimation drying), and secondary drying (removal of bound water).

In the pre-freezing, the freezing temperature is at the eutectic point (temperature at which the sample solution freezes) or lower. In order to completely freeze the sample solution, it is desirable to freeze at about −40° C. This is because in a multi-component solution, the freezing temperature is low and the freezing mechanism is also complex.

In the primary drying, the still-frozen sample is sublimed while preventing dissolution by drying at the eutectic point or lower. The degree of vacuum at this stage is desirably 100 Pa or less. The boiling point of water at 100 Pa is about −20° C.

In the secondary drying, bound water is removed (water in a molecular state that is adhered to the reagent components is removed). The reagent is heated to the permissible temperature of the reagent to improve the degree of vacuum (increase the degree of dryness of the reagent).

The reagent used in the reaction is dispensed to solidification tubes in just the required amount. A tube that is thin and that easily transmits heat is suitable for the solidification tubes. To rapidly cool and freeze the solution dispensed in the tubes, an aluminum block is placed in advance in a freezer (−40° C.) to cool.

The aluminum block is provided with depressions that have a size into which the solidification tubes can be placed. The tubes into which the reagent has been dispensed were placed on those depressions. The reagent can be efficiently frozen by the cooled aluminum block. The freezing time was 6 hours or more.

It is noted that that the reagents used in this example are a reagent (PM) including an EB virus primer and a reagent (RM) including Bst DNA polymerase. In this example, the PM and the RM were mixed over ice, and the resultant mixture was dispensed over ice into each tube. The tubes were then immediately placed in the −40° C. freezer to freeze (pre-freezing). The freezing time was 6 hours or more.

It is noted that that the reagents used in this example are a reagent (PM) including an EB virus primer and a reagent (RM) including Bst DNA polymerase. In this example, the PM and the RM were mixed over ice, and the resultant mixture was dispensed over ice into each tube. The tubes were then immediately placed in the −40° C. freezer to freeze (pre-freezing). The freezing time was 6 hours or more.

The frozen reagent was placed while still on the aluminum block in the drying chamber of a freeze dryer (FDU-2200 EYELA), and the pressure was reduced. The reason for placing together with the aluminum block is to prevent the frozen reagent from dissolving before reaching the degree of vacuum at which sublimation starts. The cooling trap temperature in the freeze dryer was about −87° C. Since the sublimed moisture is re-frozen by the cooling trap, there is no entry of the moisture into the vacuum pump. The degree of vacuum in this example was 4 to 8 Pa. The primary drying was carried out in this state for about 12 or more hours. Then, the secondary drying was carried out for about 6 or more hours by setting the shelf temperature in the drying chamber to 30° C.

The freeze-dried reagent was solidified while still frozen. Consequently, a freeze-dried reagent that is dispensed into a differently-shaped container is solidified in the shape of the container.

When the reagent is placed in the microchip wells, it is desirable to do so with a shape that can be identified from above or below. Consequently, the reagents are solidified by a container having a different planar shape for each reagent. The size of the planar shape is smaller than size of the wells. Although the height of the solidified reagent depends on the reagent amount, it is desirably lower than the height of the wells.

An illustration of solid-phase reagents having different shapes placed on the microchip is illustrated in FIG. 1.

The reagent shape may be any shape, as long as it is a shape that can be identified from an image, for example. The image identification algorithm can be pre-registered in the image to act as the master, and a determination can be made based on the degree of match between that image and the shape.

Examples of the shape may include shapes having a different number of angles or sides (FIGS. 2A to 2F). The shape can also have the same number of angles or sides, as long as it is an identifiable shape (FIGS. 2G to 2I).

After freeze-drying, the reagent may be compressed by applying pressure with a tableting machine, for example, to a level at which the rate of dissolution is not decreased.

To carry out molding while maintaining solubility, an excipient, a disintegrating agent, a binder, a lubricant and the like may be added. It is preferred that these additives do not influence a nucleic acid amplification reaction.

The reagents solidified in the container can be extracted by gently sandwiching between a pair of tweezers so as not to crush the shape, or extracted by vacuum adsorption with a pair of vacuum tweezers or the like, and moved to the microchip wells.

2) Molding from a Powder: Granulation→Tableting

Method in which a reagent formed as a powder is molded with a tableting machine.

An excipient and the like are mixed in the reagent, and then resultant mixture is turned into a powder. Examples of the method for turning into a powder include fluidized bed granulation, high-speed agitation granulation, dry granulation, spray drying, freeze-drying and the like. The molding of the powder may be carried out by a tableting method or a molding method.

In a direct tableting method, a fixed amount is placed on a template that has a flat shape different to those described above, and the powder is turned into a solid by applying an optimum pressure. To maintain solubility even after solidification, an excipient, disintegrating agent, a sugar and the like may be added.

In a molding method, a mixed powder including the drug is granulated with water or a water/alcohol binder, and is tableted under low pressure while still moist. Then, the solvent is evaporated to increase the number of pores.

<Freeze-Dried Reagent in which Coloring Agent has been Added>

This method is a method in which a coloring agent is added to a molded freeze-dried reagent.

A coloring agent, for example a food dye, and a pH indicator are added to the reagent. The coloring agent may be mixed in a liquid state before freeze-drying, or a dye in powder form may be added after the freeze-drying.

Normally, for a dye that exhibits the same color hue, then the type of reagent that is arranged on the microchip can be identified by eyesight or with a camera from that color hue.

Further, if a pH indicator is used, by setting to conditions that differentiate the pH between the freeze-dried reagent state and after sample addition, the fact that the sample has been injected into the microchip can be easily determined

In addition, when using a pH indicator, in the case of a LAMP method (Eiken Chemical), for example, the pH is preferably about 8.8. To achieve this, a reagent (PM) including a primer is prepared with a pH of 8.0 or less, and a reagent (RM) including Bst DNA polymerase is prepared with a pH of 8.8 or higher, so that the pH during mixing of the PM, the RM, and a sample solution after the sample solution has been injected is about 8.8. Consequently, the pH indicator included in the PM reagent causes the color hue to change based on a change in the pH.

For example, if the PM has a pH of 6.5 and Phenol Red is added, the PM reagent exhibits a yellow color. The PM reagent is then arranged in the microchip wells together with the RM freeze-dried reagent that was prepared with a pH of 8.8 using Tris-HCl. Then, by injecting the sample, the sample and the PM and the RM in the wells are mixed. When the pH in the wells reaches about 8.8, the Phenol Red included in the PM exhibits a red color. At this stage, Pacific Blue, BODIPY FL, Rhodamine 6G, TAMRA, SYBR GreenI or the like is used for the fluorescent dye used in LAMP method detection so that there is no hindrance during optical detection.

The present technology can be utilized in, for example, a PCR extension technique, a hybridization detection technique (including a DNA chip technique), a technology relating to the detection products and assay of a PCR-amplified product, a gene expression analysis technique (including an SNP analysis technique), an immunoassay technique (an enzyme immunoassay technique etc.) and the like.

It should be understood by those skilled in the art that various modifications, combinations, sub-combinations and alterations may occur depending on design requirements and other factors insofar as they are within the scope of the appended claims or the equivalents thereof

The present disclosure contains subject matter related to that disclosed in Japanese Priority Patent Application JP 2012-150711 filed in the Japan Patent Office on Jul. 4, 2012, the entire content of which is hereby incorporated by reference.

What is claimed is:

1. A microchip for chemical reaction in which a solid-phase reagent whose reagent composition can be identified based on appearance is contained.

2. The microchip for chemical reaction according to claim 1, wherein at least two or more solid-phase reagents are contained in a reaction area where a chemical reaction is carried out.

3. The microchip for chemical reaction according to claim 1, wherein the reagent composition of the solid-phase reagent can be identified based on a shape and/or a color hue of the solid-phase reagent.

4. The microchip for chemical reaction according to claim 3, wherein the reagent composition of the solid-phase reagent can be identified based on a peripheral portion and/or a surface portion of the solid-phase reagent.

5. The microchip for chemical reaction according to claim 4, wherein the reagent composition of the solid-phase reagent can be identified based on a number of angles and/or sides of the peripheral portion.

6. The microchip for chemical reaction according to claim 3, wherein the reagent composition of the solid-phase reagent can be identified by including a coloring agent.

7. The microchip for chemical reaction according to claim 6, wherein the coloring agent is a dye and/or a pH indicator.

8. The microchip for chemical reaction according to claim 3, wherein the solid-phase reagent has been frame molded or pressure molded.

9. The microchip for chemical reaction according to claim 3, wherein the chemical reaction is a nucleic acid amplification reaction, a hybridization reaction, a PCR extension reaction, or an antigen-antibody reaction.

10. A method for fabricating a microchip for chemical reaction, comprising containing a solid-phase reagent whose reagent composition can be identified based on appearance.

11. The method for fabricating a microchip for chemical reaction according to claim 10, wherein at least two or more solid-phase reagents are contained in a chemical reaction reaction area.

12. The method for fabricating a microchip for chemical reaction according to claim 10, wherein a solid-phase reagent is contained that can be identified based on a shape and/or a color hue.

13. The method for fabricating a microchip for chemical reaction according to claim 12, wherein a solid-phase reagent is contained whose reagent composition can be identified based on a peripheral portion and/or a surface portion.

14. The method for fabricating a microchip for chemical reaction according to claim 12, wherein a solid-phase reagent is contained whose reagent composition can be identified based on a coloring agent.

15. The method for fabricating a microchip for chemical reaction according to claim 12, wherein a solid-phase reagent is contained that has been frame molded or pressure molded.

16. The method for fabricating a microchip for chemical reaction according to claim 10, comprising determining a reagent composition of the contained solid-phase reagent based on an appearance of the solid-phase reagent.

17. The method for fabricating a microchip for chemical reaction according to claim 16, wherein the appearance is a shape and/or a color hue of the solid-phase reagent.

18. The method for fabricating a microchip for chemical reaction according to claim 17, wherein the reagent composition is identified based on a number of angles and/or sides of the contained solid-phase reagent.

19. The method for fabricating a microchip for chemical reaction according to claim 17, wherein the reagent composition is identified based on a coloring agent of the contained solid-phase reagent.

20. The method for fabricating a microchip for chemical reaction according to claim 12, wherein the chemical reaction is a nucleic acid amplification reaction, a hybridization reaction, a PCR extension reaction, or an antigen-antibody reaction.
